(19) United States
(12) Patent Application Publication
(10) Pub. No.: US 2002/0129765 A1
(43) Pub. Date: Sep. 19, 2002

(54) Coating-powder spray equipment

(75) Inventor: Felix Mauchle, Abtwill (CH)

Correspondence Address: LOWE HAUPTMAN GOPSTEIN, GILMAN AND BERNER LLP, SUITE 310, 1700 DIAGONAL ROAD, ALEXANDRIA, VA, 22314

(73) Assignee: ITW GEMA AG,

(21) Appl. No.: 10/095,966

(22) Filed: Mar. 13, 2002

(30) Foreign Application Priority Data
Mar. 13, 2001 (DE) 101 11 891.0

(51) Int. Cl. B05C 5/00

(52) U.S. Cl. 118/308

(57) ABSTRACT

Coating-powder spray equipment comprising a regulator (22) for the total air rate in a total-air line (16) and one air-rate adjusting element (46) solely in one of the two lines “conveying-air line (36)” or “accessory-air line (40)”, the other of said two lines being devoid of any adjusting element.

The present invention relates to coating-powder spray equipment defined in the preamble of claim 1.

Accordingly the invention relates to coating-powder spray equipment containing an injector acting as the feed pump and comprising a conveying-air intake to aspirate powder out of a powder receptacle into a partial-vacuum zone of said injector and a powder outlet for the powder conveyed pneumatically by said conveying air; further a conveying-air line connecting the total-air line to the conveying air intake of the injector, and an accessory-air line connecting the total-air line to an accessory-air intake of the injector to feed accessory air into the flow path of the mixture of powder and conveying air.

The European patent document 0 636 420 B1 discloses coating-powder spray equipment of this kind that is fitted both in the conveying-air line and in the accessory-air line with one volumetric regulator of conveying air. Depending on a setpoint powder rate and on a measured powder rate, and using stored graphical data, the volumes per unit time of conveying air and accessory air are regulated in order to regulate the powder rate (quantity of powder conveyed per unit time). The graphical data contains a powder-rate axis, a volumetric conveying-air axis and several total-volume axes. Moreover, the accessory-air volume must be calculated by a computer from the difference between the volume of total air less the volume of conveying air, that is, the particular air rate (volume of air moved per unit time).

The patent document EP 0 412 289 B1 discloses coating-powder spray equipment fitted with one pressure regulator both in the conveying-air line and in the accessory-air line. The total-air feed line of these two tap-lines contains a flowmeter with optical display of the total-air rate (total volume of air moved per unit time). Manually adjusting the conveying-air pressure regulator will set the quantity of conveyed powder. Thereupon the pressure regulator of the accessory-air line is fine-tuned until the flowmeter again displays the original flow that it did display before adjusting the conveying-air regulator. The purpose of this operation is to simplify an operator's use of the coating-powder spray equipment compared with the earlier manual use of complex graphs that required the operator to elicit the relations between pressure of the conveying air, pressure of the accessory air and total flow of air as well as the desired powder rate (quantity of powder in g/min).

The U.S. Pat. No. 3,625,404 discloses a branching valve comprising a pressure regulator, a total-air intake for pressure-regulated total air, a conveyance-air outlet and an accessory-air outlet. It contains two valves associated with a common valve element opening one valve for the conveying air when closing the valve for the accessory air, and vice-versa.

Very small changes in the pressures and in the ratios of the pressures in the conveying-air line to the accessory-air line already may entail undesirably large changes in the rate of powder conveyed per unit time. The powder rate ordinarily is stated in g/min though it also might be defined in volume per unit time. All air quantities are appropriately defined in air volumes. Therefore all air volumes per unit time cited below will be denoted as air rates.

In practice changes in the flow impedance of the powder/air mixture may arise when changing a powder hose between the injector and spray equipment, when changing the injector or when changing the spray element of the spray equipment. The spray equipment may a so-called manual spray gun with or without a grip or an automatic spray gun. The spray equipment's spray element may be a spray nozzle or a rotary atomizing element.

The air serves merely to pneumatically convey the powder. The powder flow must exhibit a minim speed and hence it entails a minimum air rate in order that powder particles shall not be deposited along the path traveled by the powder. When the speeds of the powder/air mixture are below 10 to 15 m/s, pulsations shall arise in the flow of the powder/air mixture. On the other hand a high rate of air is undesirable because requiring energy and there being danger that the powder be blown off the object to be coated. A practical value of the powder rate is 300 g/min.

The objective of the present invention is to simplify the coating-powder spray equipment disclosed in EP 0 636 420 B1, to render it more economical and to attain a more responsive regulation dynamics while retaining the advantages that the flow impedances on the path traveled by the mixture of powder and air shall not adversely affect the actual powder rates.

This problem is solved by the features of claim 1.

In the invention, the conveying and the accessory airs are mutually “decoupled” in that only one adjusting element henceforth shall be required for one of the two and that nevertheless the total air rate shall be automatically kept constant for all setpoints of different reference powder rates. The setpoints of the adjusting element and of the total-air rate regulator may be constant or variable. The invention requires an adjusting element changing and setting the flow impedance only in one of the two tap-lines for conveying air or air tap-line, but not in the other. The other tap-line requires no adjusting elements at all, neither for setpoints nor in the form of a pressure regulator or volumetric control. Preferably the two tap-lines shall be devoid of any air pressure regulator or volumetric flow control.

The invention substantially simplifies the powder-coating spray equipment and makes it more economical. Fewer of these components are required and those are controlled and regulated in simpler manner. Also the regulation dynamics of the invention is more responsive than that of the state of the art.

The dependent claims state further features of the invention.

The adjusting element and hence the magnitude of its flow cross-section can be designed to be manually adjustable., However, in a preferred embodiment of the invention, a regulator is used which drives the adjusting element—as a function of the powder-rate setpoint—at a powder-rate setpoint input and as a function of a measured powder rate, by a powder rate sensor generating a signal of the measured powder rate as a function of the powder (weight or volume) conveyed per unit time.

The adjusting element may be configured either in the conveying-air line or in the accessory-air line.

In a special embodiment of the invention, the adjusting element is in the form of a valve, a cock, a flow throttle or stop, and can be adjusted in its flow cross-section.

In combination with a regulator, the adjusting element is adjusted by the former as a function of the setpoint powder rate and of a measured powder rate and acts as a volumetric control. The volumetric control sets the cross-section of flow and hence the flow impedance of the pertinent tap-line (conveying-air line or accessory-air line). In this manner that volumetric air flow is determined which automatically also depends on the flow impedance in the other tap-line and on the predetermined total air rate.

In theory the adjusting element also may be a pressure regulator, however the latter is undesirable for regulating purposes because changing the flow cross-section as a function of pressure.

The invention is elucidated below in relation to the drawings and illustrative preferred embodiments.

FIG. 1 schematically shows powder spray equipment of the invention,

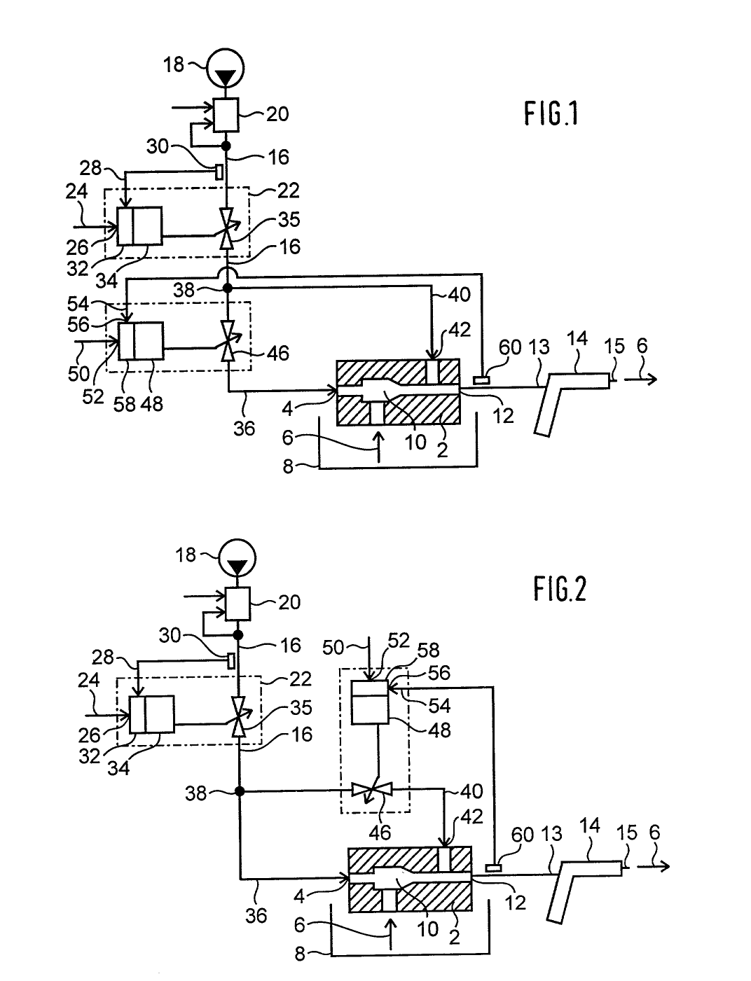

FIG. 2 schematically shows another embodiment of powder spray equipment of the invention,

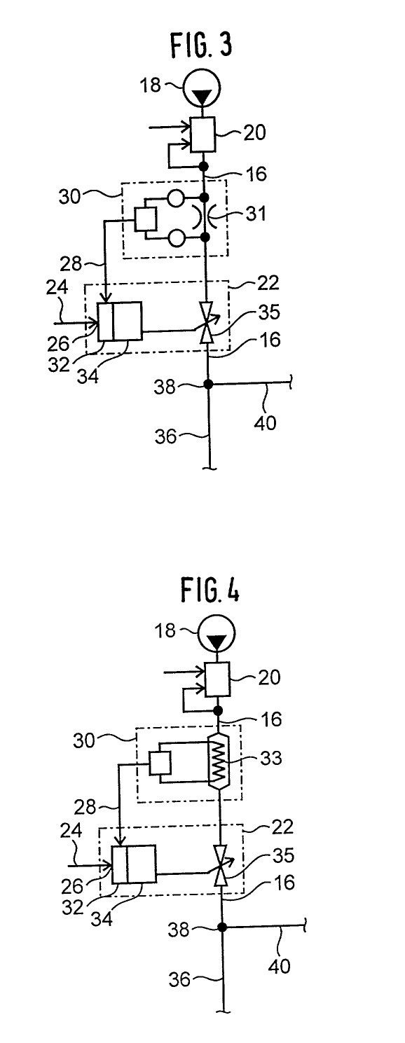

FIG. 3 shows a special embodiment of a regulator of the total-air rate of the powder spray equipment of FIGS. 1 and 2,

FIG. 4 shows another special embodiment of the regulator of the total-air rate of the powder spray equipment of FIGS. 1 and 2,

FIG. 5 shows a further embodiment of powder spray equipment of the invention similar to that of FIG. 1, and

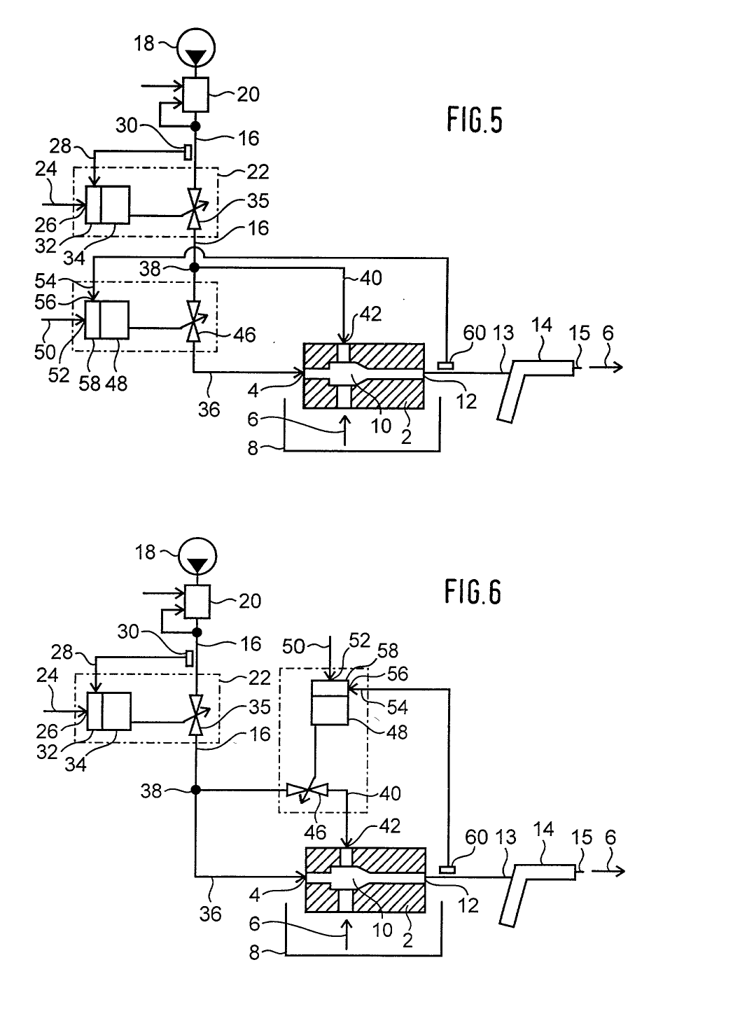

FIG. 6 shows a further embodiment of the powder spray equipment of the invention similar to that of FIG. 2.

The coating-powder spray equipment of the invention shown in FIG. 1 comprises an injector 2 fitted with a conveying-air intake 4 for conveying air aspirating powder 6 out of a powder receptacle 8 into an injection partial-vacuum zone 10, further a powder outlet 12 for the powder pneumatically conveyed by the conveying air. The powder 6 may be pneumatically conveyed by the injector 2 through a powder hose 13 into another, omitted powder receptacle or to a spray system 14 spraying said powder onto an object to be coated and for that purpose being fitted with a spray nozzle or a rotary atomizer. Preferably the spray system 14 includes at least one high-voltage electrode 15 to electrostatically charge the powder 6.

A total-air line 16 is connected to a compressed-air source 18 and contains, as seen in the direction of flow of said air, consecutively a total-air pressure regulator 20 and a total-air rate regulator 22. The total-air rate regulator 22 regulates the total air conveyed per unit time, for instance the total air volume per unit time, and maintains this rate essentially constant at a total-air rate setpoint intake 26 as a function of a total-air rate setpoint 24 and as a function of a measured total-air rate 28 of a total-air rate sensor 30. The setpoint value 24 and the measured value 28 of the total-air rate are compared against each other at 32 by conventional regulation techniques. A total-air rate setpoint element 35 is driven by a total-air regulator 34 as a function of the above comparison. The sensor 30 of the measured total-air rate may be mounted upstream or downstream of the total-air rate adjusting-element 35 in or on the total-air line 16, depending on the type of the regulator 22 for the total-air rate.

A conveying-air line 36 connects the total-air line 16 to the conveying-air intake 4 of the injector 2 at a tap site 38 downstream of the total-air rate regulator 22.

An accessory-air line 40 connects the total-air line 36 to an accessory-air intake 42 of the injector 2 at a tap site 38 downstream of the total-air rate regulator 22, said intake 42 feeding accessory air from the total-air line 16 into the flow path of the powder/conveying-air mixture, preferably at a site far enough downstream of the injector/partial-vacuum zone 10 that the accessory air no longer can affect the partial vacuum in said region. On the other hand the accessory-air intake 42 must be close enough to the injector/partial-vacuum zone that said accessory air can contribute in precluding powder deposits along the flow path of the powder/conveying-air mixture. The accessory-air intake 42 of the “injector” therefore may be configured within the injector 2 or outside it but near its downstream end. Designs wherein the accessory-air intake 42 issues into the injector/partial-vacuum zone 10 are elucidated below in relation to FIGS. 4 and 5. The tap side 38 can be the same for the conveying-air line 36 and the accessory-air line 40.

The total-air rate regulator 22 keeps constant the total-air rate (quantity of air, for instance air volume per unit time) through the total-air line 16.

A tap-line adjusting element 46 to change and set the flow impedance of a pertinent tap line is mounted in one of the two tap lines “conveying-air line 36” or “accessory-air line 40”. This tap-line adjusting element 46 is fitted with a cross-sectionally variable air feed. By adjusting the size of the flow cross-section, the flow impedance shall be set in the pertinent tap-line and hence also the ratio of the flow impedances of the two tap lines 36 and 40. The air rates (air quantity, preferably volume per unit time) that may flow through the tap lines behave inversely to the flow impedances. The smaller the impedance, the larger the air rate of the particular tap line 36 or 40. It means that only one tap-line adjusting element 46 is required in one of the two tap lines 36 and 40, the other tap line 40 or 36 requiring none at all and preferably also shall be without one. The apportioning of the tap-line air rates automatically depends always on the ratio of flow impedances of the two tap lines, and the air rates in the two tap lines 36 and 40 additionally depend on the total-air rate—which is kept constant by the total-air rate regulator 22 of the total-air line 16.

FIG. 1 shows the tap-line adjusting element 46 being mounted in the conveying line 36. Accordingly the accessory-air line 40 is entirely devoid of flow adjusting elements. The tap-line adjusting element 46, which is shown in FIG. 1 being in the conveying-air line 36, therefore in one embodiment mode may be manually adjustable and be fitted with an optical readout scale appropriately displaying not the adjustable magnitudes of the flow cross-section but preferably the setpoint powder rate that can be supplied by the injector 2, or percentages corresponding to a range of powder rates.

In the preferred embodiment mode, the tap-line adjusting element 46 can be driven by a regulator 48 as a function of a setpoint powder rate 50 at a powder-rate setpoint input 52 and as a function of a measured powder rate 54 at a measured powder-rate input value 56. The measured powder rate signal 54 is generated by a measured powder rate sensor 60 mounted in or near the injector 2 or at/in the flowpath of the powder 6. The powder-rate setpoint and measured values 50 and 54 are compared at 58. As a result of this comparison, the powder-rate regulator 48 always shall drive the tap-line adjusting element 46 accordingly.

The powder-rate setpoint-input 52 may be a manual input or an electronic input to automatically apply a desired powder-rate setpoint value. Again the total-air setpoint input 26 of the total-air regulator 22 may be a manual input or an electronic input to automatically apply total-air setpoint values. Automatic setpoint inputs 52 and 26 allow fully automated control of the spray-coating Equipment as a function of the objects to be coated.

It is clear that the two tap lines “conveying-air line 36” and “accessory-air line 40” are wholly separate as regards process technology in such a way that only one of them requires an adjusting element 46.

The air rates are quantity of air per unit time, preferably air volume per unit time. The powder rates are quantity of powder per unit time, preferably weights of powder, for instance g/min, however also volume per unit time.

As regards FIG. 1, the more the adjusting element 46 shall be opened in the conveying-air line 36, the more conveying air shall flow through this line 36, while commensurately less accessory air shall flow through the accessory-air line 40. Vice-versa, the more the adjusting element 46 in the conveying-air line 36 shall be closed, the less conveying air shall flow through this line 36 while commensurately more accessory air shall flow through the accessory-air line 40.

In the description below concerning FIGS. 2 through 6, only the differences relating to FIG. 1 shall be discussed, all other features and functions of FIG. 1 also being present in FIGS. 2 through 6.

As regards FIG. 2, the tap-line adjusting element 46 is situated in the accessory-air line 40 and as a result the conveying-air line 36 does not require an adjusting element and preferably shall be devoid of one. The more the adjusting element 46 of the accessory-air line 40 shall be opened, the more accessory air shall flow through it, while commensurately less conveying air shall flow through the conveying-air line 36. The more the adjusting element 46 of the accessory-air line 40 shall be closed, the less accessory air shall flow through the accessory-air line 40 while commensurately more conveying air flows through the conveying-air line 36.

As regards the special embodiment of a total-air rate regulator 22 shown in FIG. 3, the sensor 30 of the measured value of the total-air rate is a pressure-differential sensor generating a measured volumetric signal by measuring the differential pressure across a defined flow impedance 31, for instance a throttle or a standardized baffle situated in the total-air line 16 upstream of the total-air adjusting element 35.

FIG. 4 shows an embodiment of the total-air rate regulator 22 whereby the sensor 30 of the measured value of the total air generates a measured value signal of the total volumetric flow using an electric hot wire 33 situated in the flow path of the total air in the total-air line 36 and being cooled thereby as a function of the total amount of air flowing past this hot wire per unit time. The sensor 30 measuring the value of total air and its hot wire 33 may be configured upstream of the total-air adjusting element 35 as shown in FIG. 4, though also downstream of it.

FIG. 5 corresponds to FIG. 1 except that the accessory-air intake 42 issues into the injector partial-vacuum zone 10.

FIG. 6 is identical with FIG. 2 except that the accessory-air intake 42 issues into the injector partial-vacuum zone 10.

Whereas the rate of accessory air affects the powder rate little or not at all in the embodiments of FIGS. 1 and 2 and this powder rate substantially is determined by the rate of conveying air in the conveying-air line 36, on the other hand the rate of accessory air in the embodiments of FIGS. 5 and 6 will affect the magnitude of the partial vacuum in the injector partial-vacuum zone 10 and hence also the rate of the powder aspirated by the conveying air of the conveying-air line 36 in the partial-vacuum zone 10. The injectors 2 of FIGS. 1 and 2 as well as the injector 2 of FIGS. 5 and 6 are from the state of the art.

1. Coating-powder spray equipment, comprising an injector (2) acting as the feed pump and fitted with a conveying-air intake (4) for conveying air aspirating powder out of a powder receptacle (8) in an injector partial-vacuum zone (10) and a powder outlet (12) for the powder pneumatically conveyed by said conveying air, further a total-air line (16), a conveying-air line (36) connecting the total-air line to the conveying-air intake (4) of the injector (2), an accessory-air line (40) connecting the total-air line (16) to an accessory-air intake (42) of the injector (2) for the purpose of feeding accessory air into the flowpath of the mixture of powder and conveying air,
characterized in that a total-air rate regulator (22) regulating the volume per unit time of conveyed total air is mounted in the total-air line (16) upstream of the conveying-air line (36) and downstream of the accessory-air line (40), in that a tap-line adjusting element (46) is mounted in one of the two tap-lines “conveyance line (36)” or “accessory-air line (40)” to change and set the flow impedance of that tap-line, the flow impedance of the other tap-line (40 or 36) being independent of the adjustments of this tap-line adjusting element (46) and also independent of adjustments of the total-air rate at the total-air rate regulator (22), in such a way that the ratio of the air rates in the two tap-lines (36, 40) shall solely be determined the one tap-line adjusting element (46) and the total-air rate for jointly both tap lines (36, 40) shall be determined solely by the total-air rate of the total-air rate regulator (22).

2. Powder-spray coating equipment as claimed in claim 1, characterized in that the conveying-air line (36) shall be the tap-line which is fitted with the tap-line adjusting element (46).

3. Powder-spray coating equipment as claimed in claim 1, characterized in that the tap-line which is fitted with the tap-line adjusting element (46) shall be the accessory-air line (40).

4. Powder-spray coating equipment as claimed in one of the above claims, characterized in that the adjusting element may be driven by a drive from the group of a valve, cock, flow throttle or flow baffle, where the flow cross-section of said drive shall be controllable.

5. Powder-spray coating equipment as claimed in one of the above claims, characterized by a regulator (48) driving the tap-line adjusting element (46) as a function of a powder-rate setpoint (52) at a powder-rate setpoint-input (50) and as a function of a measured value (54) of the powder rate at a measured-value sensor (60) of the powder rate, said sensor (60) generating a measured value of the powder rate as a function of the quantity of powder applied per unit time.

6. Powder-spray coating equipment as claimed in one of claims 1 through 4, characterized in that the flow cross-section of the tap-line adjusting element (46) is manually adjustable.
